(19) United States
(12) Patent Application Publication
(10) Pub. No.: US 2002/0146955 A1
(43) Pub. Date: Oct. 10, 2002

(54) Pliable pad for collecting and absorbing liquids

(76) Inventor: Daniel S. Levine, Wayne, PA (US)

Correspondence Address: Gary M. Cohen, Esq., Strafford Building Number Three, Suite 300, 125 Strafford Avenue, Wayne, PA, 19102, US

(21) Appl. No.: 10/165,331

(22) Filed: Jun. 7, 2002

Related U.S. Application Data
(63) Continuation-in-part of application No. 09/691,272, filed on Oct. 18, 2000.
(63) Continuation-in-part of application No. PCT/US01/32374, filed on Oct. 16, 2001.

(51) Int. Cl. B32B 5/16; D04H 1/00; D04H 3/00; B32B 15/14; B32B 27/12; D04H 5/00; D04H 13/00

(52) U.S. Cl. 442/328; 442/376; 442/381; 442/393; 442/394; 442/413; 442/414

(57) ABSTRACT

A pliable pad is provided with expandable portions that can be deployed to assist the user in shaping the pliable pad into a basin. Folded or crinkled regions can be provided for connecting portions of the pliable pad that are to provide end walls for the basin, when deployed, with portions of the pliable pad that are to provide the side walls for the resulting basin. Selected portions of the pliable pad can be provided with the expandable portions or, if desired, the entire structure of the pliable pad can be provided with expandable structures. The expandable portions are preferably coupled with structures for developing a hinge that can assist in effective deployment of the expandable portions, and the pliable pad, to form the desired basin-like shape.

### RELATED CASES

This is a continuation-in-part of a U.S. patent application which is to derive from an International (PCT) Application, No. PCT/US01/32374, which designates the United States and which has been assigned an International Filing Date of Oct. 16, 2001, and which is also a continuation-in-part of prior copending U.S. patent application Ser. No. 09/691,272, filed Oct. 18, 2000.

### BACKGROUND OF THE INVENTION

This invention relates primarily to the fields of wound treatment and surgery, and more particularly, to improvements in the formation of a basin which can be used to collect liquid used in wound irrigation. The present invention can also be used in other fields, including non-medical applications.

Absorbent pads are routinely used in clinics and in homes. Such pads essentially comprise a combination of an absorbent material and a fluid barrier. A mesh is typically provided over the absorbent material to retain the absorbent material against the fluid barrier, which serves as a backing for the pad.

For use in irrigating a wound, known absorbent pads have generally been found to be insufficient because unabsorbed, contaminated liquid frequently spills from the periphery of the pad. The spilled liquid constitutes a safety hazard and a health hazard, and frequently requires corrective action.

### SUMMARY OF THE INVENTION

To overcome these and other problems associated with known absorbent pads, a pliable pad has been developed which can be shaped into a trough or basin (either before use or in situ) for containing excess liquid. In this way, the pliable pad can prevent liquid from spilling from the trough or basin which is formed (e.g., onto the floor or onto medical personnel).

The pliable pad can also be used in non-medical applications such as the containment of liquid leaking from a plumbing fixture or from a machine. This can be especially useful in situations in which a simple pan or bucket cannot be deployed because of limited access, or when such devices would provide inadequate containment of a leak or spray. In such cases, the pliable pad can be used to overcome the problems associated with the use of simple pans or buckets by introducing the pliable pad in one configuration (e.g., flat or partially folded) and by then shaping the pliable pad, in place, to address the problems associated with limited access. In addition, the pliable pad can be shaped to surround the leak, to limit or even eliminate any spray that might otherwise escape.

U.S. patent application Ser. No. 09/691,272, the subject matter of which is incorporated by reference as if fully set forth herein, describes a basic configuration for the pliable pad which is comprised of an absorbent material arranged adjacent to a formable material. The absorbent material and/or the formable material can further include a barrier to liquid, or a separate liquid barrier layer can be provided.

The formable material is preferably chosen so that it can be shaped manually, and so that the desired shape will be retained indefinitely if left undisturbed. The formable material can then be manipulated by hand, or by machine, to form a wall or a series of walls, so that the pliable pad can form a fluid-collecting basin. As examples, the pliable pad can be made formable by mating the absorbent material with a sheet formed of a metal or a metal foil, or by embedding an elongated bendable member (e.g., a wire, rod or tube) within the absorbent material or within a sheet (or sheets) resting upon the absorbent material or to which the absorbent material is attached.

The resulting structure will then provide an absorbent material located within a basin which is defined by the walls created by manipulating the formable material. Any liquid that is not absorbed by the absorbent material will nevertheless be retained within the basin, providing added assurances that the fluids in question are effectively collected by the resulting structure.

The formable material can also be pre-formed to facilitate subsequent manipulation by the user into a basin-like shape. For example, International Application No. PCT/US01/32374, the subject matter of which is incorporated by reference as if fully set forth herein, describes a configuration for the pliable pad in which the formable material has corners and/or edges that can be attached, by being creased, mechanically fastened or bonded together, for example, using an adhesive or by welding, to further facilitate manipulation by the user. Edges of the formable material can also be folded to permit expansion of the structure to various sizes by the user.

The formable material, either combined with the absorbent material or prior to being combined with the absorbent material, can be folded or rolled to create a package size which is desirable for shipping and storage. The absorbent material can be combined with the formable material at any point during manufacture of the pliable pad, or prior to or during subsequent shaping of the formable material by the user. This can occur when the formable material is in a generally planar configuration, when the formable material is in the process of being formed into a desired configuration, or after the formable material has been shaped into its final configuration by the user.

In accordance with the present invention, the pliable pad is further provided with expandable portions that can be deployed to assist the user in shaping the pliable pad into a basin. For example, folded or crinkled regions can be provided for connecting portions of the pliable pad that are to provide end walls for the basin, when deployed, with portions of the pliable pad that are to provide the side walls for the resulting basin. Selected portions of the pliable pad can be provided with such expandable portions or, if desired, the entire structure of the pliable pad can be provided with expandable structures. Irrespective of their configuration, the expandable portions are preferably coupled with structures for developing a hinge that can assist in effective deployment of the expandable portions, and the pliable pad, to form the desired basin-like shape.

The present invention is also directed to various uses for the pliable pad. The primary use for the pliable pad is in irrigating wounds. To this end, the head or a limb of a patient is placed on a pliable pad which is manipulated to form a basin to contain the appendage. The desired irrigation step is then performed. During such irrigation, liquid is capable of being absorbed by the absorbent material, and any liquid that is not absorbed by the absorbent material is collected in the basin defined by the pliable pad.

The pliable pad of the present invention also has uses in fields other than medicine. For example, the pliable pad can be used to collect water leaking from plumbing fixtures, such as sinks, or to collect liquids that drain or leak from machinery. Any of a variety of uses are possible.

For a further description of the pliable pad of the present invention, reference is made to the description which is provided below, together with the following drawings.

### BRIEF DESCRIPTION OF THE DRAWINGS

FIG. 1 is an isometric view showing an embodiment of the pliable pad of the present invention which includes expandable end portions.

FIG. 2 is a side elevational view of the pliable pad shown in FIG. 1.

FIGS. 3A to 3C are sequential, isometric views illustrating deployment of the pliable pad shown in FIG. 1.

FIG. 4 is an enlarged, partial isometric view showing an alternative embodiment of the pliable pad which includes an optional hinge for assisting with deployment of the expandable portions, and the pliable pad, to form a basin.

### DETAILED DESCRIPTION OF PREFERRED EMBODIMENTS

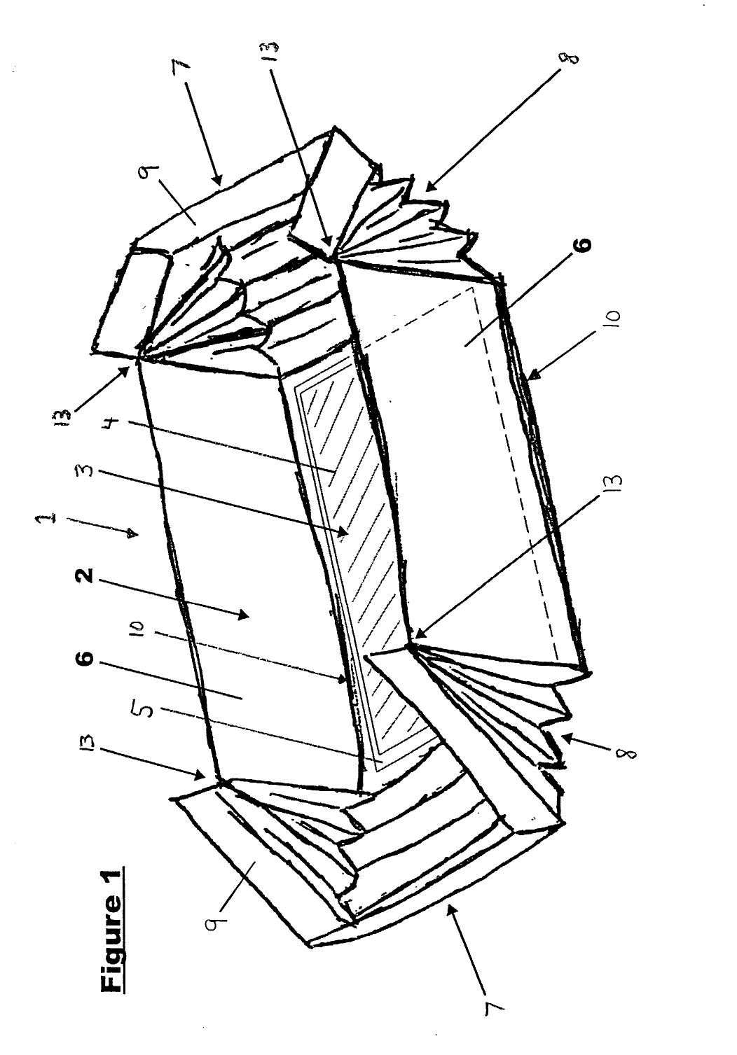

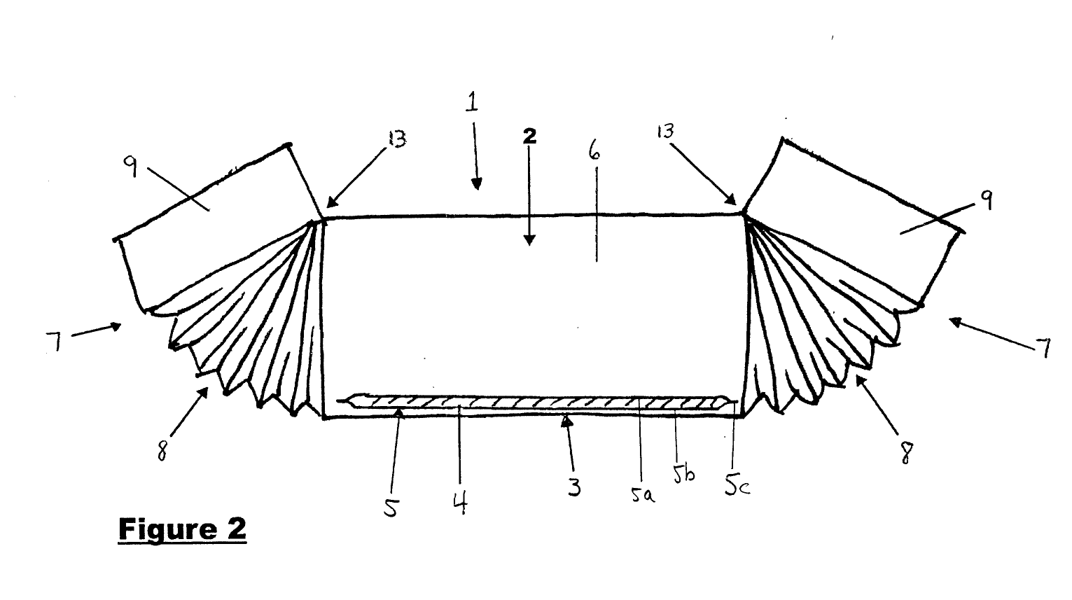

FIGS. 1 and 2 show an embodiment of a pliable pad 1 which is produced in accordance with the present invention. As used in this specification, the term “pliable pad” refers to the entire composite structure described below.

The pliable pad 1 has been shaped to form a basin 2, defining a center section 3 which includes a layer 4 formed of an absorbent material. The absorbent layer 4 can be formed of a superabsorbent polymer, an absorbent fabric, an absorbent gauze, a pulp material, cotton or the like, or any other material capable of absorbing liquids.

The absorbent layer 4 is preferably surrounded with and enclosed by an outer layer 5 for encasing the layer of absorbent material. The primary purpose of the outer layer 5 is to allow fluid to pass through, to the layer of absorbent material, while preventing particles or fibers of the absorbent material from being released into an open wound. A secondary purpose of the outer layer 5 is to provide a means for reliably locating the absorbent layer 4 relative to the center section 3, e.g., by securing the outer layer 5 and, as a result, the absorbent layer 4, to the center section 3 when deemed appropriate.

For some applications, such as in an operating room, the outer layer 5 may not provide sufficient protection against the release of dust particles from the absorbent material. In such cases, the absorbent material can be formed of a material such as absorbent gauze or superabsorbent fibers, which tend not to release particles. The outer layer 5 can be omitted in such cases, or retained, as preferred.

The outer layer 5 will typically be formed of a mesh, non-woven, or equivalent material capable of allowing fluid to pass through the outer layer 5 and to the absorbent material which is contained by the outer layer 5. The outer layer 5 will preferably completely encase the absorbent layer 4, and either can simply rest on the absorbent layer 4 or can be attached to the absorbent layer 4 using, for example, an adhesive, heat welds, or other equivalent fastening means. In the illustrative embodiment shown, the outer layer 5 is implemented as a top layer 5a and a bottom layer 5b which are connected along a seam 5c (e.g., a heat-sealed seam) to complete the outer layer 5. Alternatively, the bottom layer 5b can be omitted and the top layer 5a can be attached to the center section 3, if desired.

The outer layer 5 can be comprised either entirely of one material, such as a mesh, or can be constructed from a combination of mesh-like and liquid-impervious materials. For example, a liquid-impervious material can be used for the top layer 5a and a mesh material can be used for the bottom layer 5b. In this arrangement, the liquid-impervious material positioned along the top of the outer layer 5 serves to keep a body part being treated from resting in a direct fluid path with the absorbent material. Fluid is allowed to flow over the facing defined by the top of the outer layer 5, through the mesh forming the bottom of the outer layer 5, and to the absorbent layer 4, in this way limiting the amount of fluid that the appendage contacts directly.

In cases where the outer layer 5 is constructed from a combination of mesh-like and liquid-impervious materials, the outer layer 5 can be implemented either as a single layer, or as plural sections or multiple layers of material. For example, the mesh material can fully encase the absorbent layer 4, and sections of liquid-impervious material can-be used to form a second layer on top of or beneath the mesh material along the top and/or the bottom of the outer layer 5, so that only the bottom allows fluid to reach the absorbent layer 4. Alternatively, and as mentioned previously, the outer layer 5 can be eliminated if preferred.

The absorbent layer 4, with or without the outer layer 5, can further be provided with a backing layer (not shown) to form a liquid barrier. Such a backing layer can be formed as one or a plurality of layers formed of selected liquid-retaining materials (which may be the same or different from one another). Preferred liquid-retaining materials can include any of a variety of plastic sheet materials or plastic coatings, with particularly preferred materials for developing the liquid barrier including plastic films formed of vinyl, polyethylene, polypropylene or some other equivalent plastic.

Shaping of the basin 2 is accomplished responsive to a “formable material” which, as used in this specification, will refer to any material which is capable of assuming a desired shape and of retaining the desired shape which has been assumed. Preferred examples of such formable materials include thin sheets of aluminum or aluminum foil, metal wires, rods or bands, or other structurally equivalent materials. The formable material can be provided in a smooth condition, or can be crinkled or dimpled to increase its strength, as desired. Any of a variety of structurally formable materials can be used, provided the selected material is bendable and can retain its shape after being formed into a particular configuration, and the selected formable material can be implemented as a single layer, as plural layers, or as a composite which includes the formable material, as desired.

In FIGS. 1 and 2, the pliable pad 1 has been shaped to form the basin 2, placing the absorbent layer 4 (or pad) in the center section 3 of the resulting basin 2. To this end, the basin 2 is preferably developed with a layer which is itself comprised of the formable material, although other formable layers could also be used to achieve a similar result. For example, the formable layer could be implemented as a sheet, formed of a paper and/or plastic material, which includes a formable wire, rod or band, if desired. In the illustrative example shown in FIGS. 1 and 2, the formable material used to shape the basin 2 is implemented as a foil layer, such as a metal foil, which retains its shape after bending.

The resulting basin 2 includes opposing side walls 6 and opposing end walls 7. The opposing end walls 7 are formed by and within folded sections 8 which are produced from the formable material which develops the basin 2. The end walls 7 can also be developed using other shapeable structures, such as pleated, gusseted or crinkled regions developed in the formable material. The end walls 7 can further include extensions 9, joined to the end walls 7, in cases where it is desired to provide the end walls 7 with additional height or overall extension.

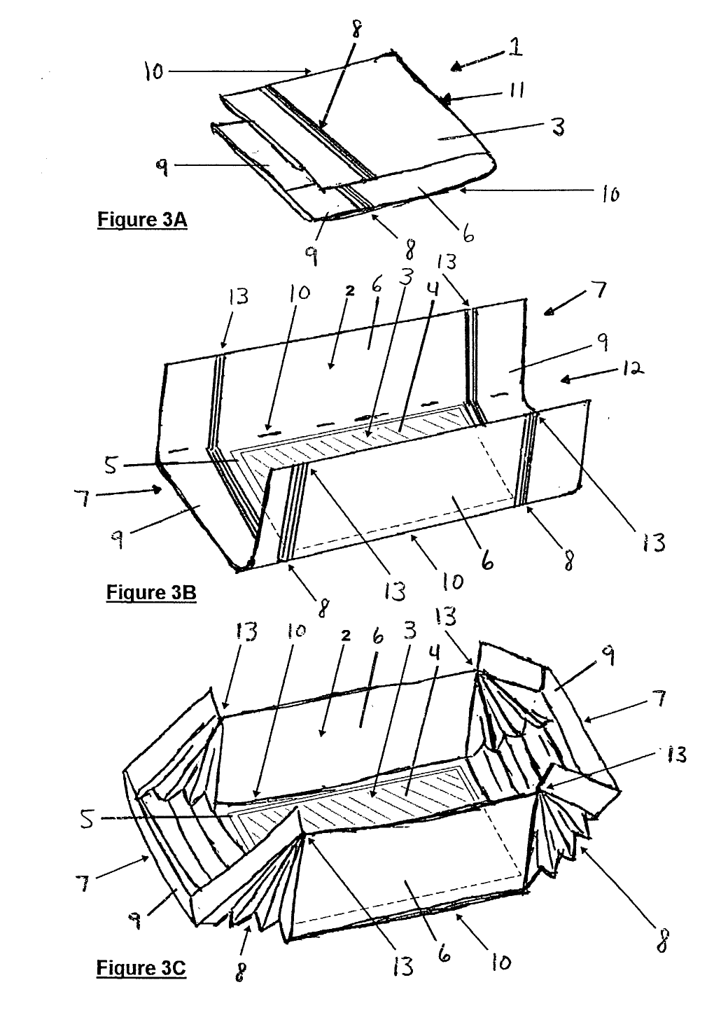

FIGS. 3A to 3C show progressive deployment of the pliable pad 1. In FIG. 3A, the pliable pad 1 is in a folded configuration that is advantageous for packaging and storage. The particular configuration shown in FIG. 3A is illustrative only, it being understood that the pliable pad 1, or other structural combinations for developing a pliable pad produced in accordance with the present invention, can assume any of a variety of folded configurations other than the configuration selected for illustration in FIG. 3A.

In the illustrative configuration shown in FIG. 3A, the side walls 6 are folded inwardly along creases 10, overlapping each other as well as the center section 3 of the pliable pad 1. The absorbent layer 4 can either be mated with the initially folded structure, positioned between the center section 3 and the side walls 6 which are then folded over the center section 3, or separate from the initially folded structure, for subsequent placement in the deployed basin 2. The folded sections 8 for developing the expandable end walls 7 are initially compressed (or gathered) and generally flat, with the folded sections 8 and the extensions 9, if used, forming a continuation of the overall shape of the folded side walls 6. The entire structure, with or without the absorbent layer 4, is then preferably folded (at 11) perpendicular to the creases 10 that form the side wall folds, to further reduce the footprint of the pliable pad 1 prior to deployment.

In FIG. 3B, which is an intermediary stage of the pliable pad's deployment, the fold established at 11 has been opened and the side walls 6 have been unfolded (at the crease 10) to form a generally “U-shaped” channel 12. At this point, the side walls 6 extend upwardly from the center section 3, folded along the creases 10, and the end walls 7 (to this point folded) extend from opposing ends of the “U-shaped” channel 12.

In FIG. 3C, the pliable pad 1 has been deployed to assume its desired configuration. To achieve this configuration, the folded sections 8 have been pulled outwardly and upwardly, away from the side walls 6 and the center section 3, developing the end walls 7. The creases 10 develop corners between the side walls 6 and the center section 3 which forms the bottom of the basin 2. The accordion-like shape assumed by the end walls 7 completes the basin 2, which is then made capable of receiving and containing a desired liquid. The extensions 9 are raised by deployment of the end walls 7, increasing the overall size of the resulting basin 2.

As previously indicated, the configuration shown in FIG. 3C is illustrative of any of a number of alternative configurations that can be developed by suitably shaping the side walls 6 and the end walls 7, with or without the addition of the extensions 9. The formable material allows the structure being developed to be freely shaped, as needed.

Shaping of the end walls 7 can be accomplished in a free-form fashion, by the user's hands for example, or structure can be provided for guiding deployment of the pliable pad 1. For example, the previously described creases 10 provide guidance for developing relatively squared corners between the side walls 6 and the center section 3.

It is also possible to secure portions of the pliable pad 1 to each other to guide deployment of the basin 2. For example, in FIG. 3C, the end walls 7 are deployed so that bottom portions of the folded sections 8 form an accordion-like or fan-shaped structure, while the upper portions of the folded sections 8 remain in a folded, generally compressed state. This shaping can be developed manually, by the user, or the upper portions of the end walls 7 can be fixed to develop what essentially constitutes a joint at the interface 13. Such a joint can be developed by working portions of the formable material in the vicinity of the interface 13, for example, by folding, crimping, gluing or spot welding the formable material at the interface 13, producing a joint about which the end walls 7 can be deployed.

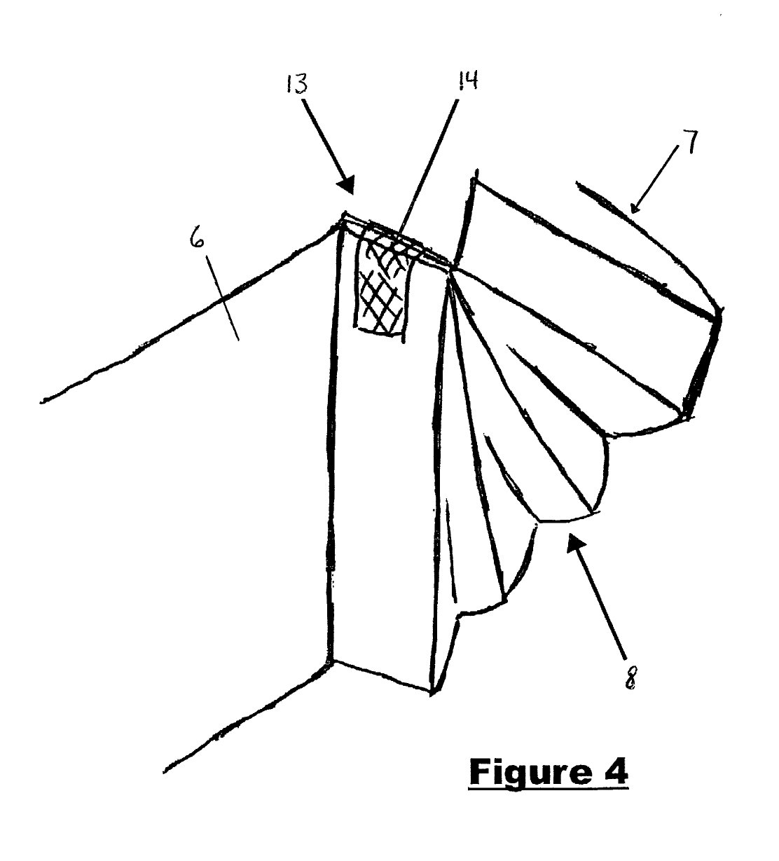

Alternatively, as is shown in FIG. 4, the interfaces 13 can be provided with hinges 14 for constraining deployment of the formable material at the upper portions of the folded sections 8. This then develops pivot points about which the upper portions of the folded sections 8 can rotate while leaving the lower portions of the folded sections 8 free to expand and pivot away from the center section 3 and the lower portions of the side wails 6 responsive to outwardly directed forces applied to the end walls 7. As a result, the unfolded sections 8 form the end walls 7 of the basin 2 as the folds are expanded around the pivot points developed by the hinges 14.

In FIG. 4, this result is achieved using tape to implement the hinges 14. In this configuration, the tape has been applied at the top of the folded (or crinkled) section 8. It is equally possible for the tape to be positioned in other arrangements to achieve a similar result. For example, instead of being placed over the top of the folded section 8, the tape could be placed along the sides of the folded section 8. A similar result could also be achieved by placing the tape between the side walls 6 and the end walls 7, across the folded section 8, to constrain the folds (or crinkles) in the folded section 8 and create desired pivots. Other hinged structures can similarly be developed to secure the interface 13 while allowing other portions of the folded sections 8 to unfold responsive to outwardly directed forces applied to the end walls 7, for example, using adhesives, mechanical fasteners or welds.

It will be understood that various changes in the details, materials and arrangement of parts which have been herein described and illustrated in order to explain the nature of this invention may be made by those skilled in the art within the principle and scope of the invention as expressed in the following claims. For example, in FIG. 4, the pivots 14 are provided at the tops of the side walls 6. Although not joined at the tops of the side walls 6 in FIGS. 1 to 3, the end walls 7 are shown in a similar configuration in which they are rotated about a pivot point 13. However, the development of a pivot point at this interface is neither required, nor the only possible placement for deployment-guiding structures. For example, pivot points can similarly be located in lower portions of the folded sections 8, so that the end walls 7 can be deployed with a sharper angle with respect to the base (the center section 3) of the pliable pad. Although two folded (pleated or crinkled) regions, each with between three to five folds, are shown in FIGS. 1 to 4, other numbers of folded regions, including any number of discrete folds, can be provided, if desired. It is also possible for the folds (pleats or crinkles) to be provided in portions of the pliable pad 1 which are to form the side walls 6 of the basin 2, or across the entire structure, from end to end, which would then allow the pliable pad to be packaged and stored in an accordion-shaped configuration prior to use. Other variations are equally possible.

What is claimed is:

1. An apparatus for collecting liquid, the apparatus comprising:
a formable layer comprising a formable material, wherein the formable material is a bendable material which is capable of retaining a shape assumed by the formable material after shaping; and
expandable portions associated with the formable layer, wherein the expandable portions are coupled with the formable layer to facilitate deployment of the apparatus into a basin for collecting the liquid.

2. The apparatus of claim 1 wherein the formable layer is a metal foil.

3. The apparatus of claim 1 wherein the formable layer includes an elongated bendable member coupled with a sheet of a flexible material.

4. The apparatus of claim 1 which further includes an absorbent layer coupled with the formable layer, wherein the absorbent layer includes an absorbent material which is capable of absorbing the liquid.

5. The apparatus of claim 1 which further includes a liquid barrier layer comprising a liquid-retaining material.

6. The apparatus of claim 5 wherein the liquid barrier layer is coupled with the formable layer.

7. The apparatus of claim 5 wherein the liquid barrier layer is coupled with an absorbent layer including an absorbent material which is capable of absorbing the liquid.

8. The apparatus of claim 1 wherein the expandable portions include a plurality of folds developed in the formable layer.

9. The apparatus of claim 8 wherein the plurality of folds develop a pleated structure.

10. The apparatus of claim 8 wherein the plurality of folds develop a gusseted structure.

11. The apparatus of claim 1 wherein the expandable portions include a plurality of crinkled regions formed in the formable layer.

12. The apparatus of claim 1 which further includes an extension coupled with at least one of the expandable portions, wherein the extension is separated from base portions of the basin by the expandable portions.

13. The apparatus of claim 1 wherein the formable layer is pre-folded into a generally planar configuration before shaping.

14. The apparatus of claim 13 wherein portions of the formable layer for forming side walls of the basin are folded over portions of the formable layer for forming a bottom of the basin.

15. The apparatus of claim 14 wherein an absorbent layer is positioned between the portions of the formable layer for forming the side walls of the basin and the portions of the formable layer for forming the bottom of the basin.

16. The apparatus of claim 14 wherein the expandable portions are developed in the formable layer adjacent to the portions for forming the side walls of the basin and the portions for forming the bottom of the basin.

17. The apparatus of claim 16 which further includes an extension adjacent to the expandable portions which is substantially coplanar with the portions for forming the side walls of the basin and the portions for forming the bottom of the basin.

18. The apparatus of claim 1 wherein the formable layer includes portions for forming side walls of the basin and portions for forming a bottom of the basin, and wherein the expandable portions are developed in the formable layer adjacent to the portions for forming the side walls of the basin and the portions for forming the bottom of the basin.

19. The apparatus of claim 18 which further includes an extension adjacent to the expandable-portions which is substantially coplanar with the portions for forming the side walls of the basin and the portions for forming the bottom of the basin.

20. The apparatus of claim 1 which further includes joints coupling portions of the expandable portions.

21. The apparatus of claim 20 wherein the joints are provided at an interface between portions of the formable layer for forming side walls of the basin and portions of the expandable portions for forming end walls of the basin.

22. The apparatus of claim 21 wherein the joints are physical connections provided at the interface which are selected from the group of connections consisting essentially of folds, crimps, glued connections and spot welded connections.

23. The apparatus of claim 21 wherein the joints are hinges for constraining deployment of the formable material.

24. The apparatus of claim 23 wherein the hinges are physical connections provided at the interface which are selected from the group of connections consisting essentially of tape, adhesives, mechanical fasteners and welds.

25. The apparatus of claim 20 wherein the joints are hinges for constraining deployment of the formable material.

26. The apparatus of claim 25 wherein the hinges are physical connections selected from the group of connections consisting essentially of tape, adhesives, mechanical fasteners and welds.

27. The apparatus of claim 20 wherein the joints are physical connections selected from the group of connections consisting essentially of folds, crimps, glued connections and spot welded connections.

28. An apparatus for collecting and absorbing liquid, the apparatus comprising:
a formable layer comprising a formable material, wherein the formable material is a bendable material which is capable of retaining a shape assumed by the formable material after shaping, and an absorbent layer comprising an absorbent material which is capable of absorbing the liquid; and
expandable portions associated with the formable layer, wherein the expandable portions are coupled with the formable layer to facilitate deployment of the apparatus into a basin for collecting the liquid.
